(19) United States
(12) Patent Application Publication
(10) Pub. No.: US 2009/0037932 A1
(43) Pub. Date: Feb. 5, 2009

(54) MECHANISM FOR BROADCASTING SYSTEM MANAGEMENT INTERRUPTS TO OTHER PROCESSORS IN A COMPUTER SYSTEM

(76) Inventors: Michael T. Clark, Austin, TX (US); Jelena Ilic, Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/831,985

(22) Filed: Aug. 1, 2007

(51) Int. Cl. G06F 9/44; G06F 13/24; G06F 15/177; G06F 15/76

(52) U.S. Cl. 719/315; 710/267; 712/30; 713/2; 712/E09.038

(57) ABSTRACT

A computer system includes a system memory, a plurality of processor cores, and an input/output (I/O) hub that may communicate with each of the processor cores. In response to detecting an occurrence of an internal system management interrupt (SMI), each of the processor cores may save to a system management mode (SMM) save state in the system memory, information corresponding to a source of the internal SMI. In response to detecting the internal SMI, each processor core may further initiate an I/O cycle to a predetermined port address within the I/O hub. The I/O hub may broadcast an SMI message to each of the processor cores in response to receiving the I/O cycle. Each of the processor cores may further save to the SMM save state in the system memory, respective internal SMI source information in response to receiving the broadcast SMI message.

### BACKGROUND OF THE INVENTION

1. Field of the Invention

This invention relates to multi-processor computer systems and, more particularly, to system management interrupt handling.

2. Description of the Related Art

Many processors include a system management mode (SMM) which allows the processor to operate in an alternative environment that can be used to monitor and manage system resources, energy use, and to run certain system level code, for example. Typically, the SMM may be entered through s system management interrupt (SMI). The SMM may include an SMI handler for handling the interrupt. Many conventional processors include a physical SMI package pin which when an appropriate voltage is applied to the pin, may force the processor into SMM. In addition there may be a number of internal SMI sources such as processor thermal notifications, for example, that may cause the processor to go into SMM.

Generally, when a processor enters SMM, the current processor state may be saved to a specific area of memory commonly referred to as system management random access memory (SMRAM). When the SMI handler finishes servicing the interrupt, the SMI handler typically calls a resume (RSM) instruction which reloads the saved state and exits SMM. In a single processor system, this arrangement works well. However, in a multiprocessor system arrangement, when one processor enters SMM, there may be system resources that are assumed to be under that processor's control, when in reality the other processors in the system may still have access to, and may modify those same system resources. This scenario may create problems in a multiprocessing environment.

### SUMMARY

Various embodiments of a mechanism for broadcasting system management interrupt information to other processors in a computer system are disclosed. In one embodiment, the computer system includes a system memory, a plurality of processor cores coupled to the system memory, and an input/output (I/O) hub that may communicate with each of the processor cores. In response to detecting an occurrence of an internal system management interrupt (SMI), each of the processor cores may save to a system management mode (SMM) save state in the system memory, information such as a bit vector, for example, corresponding to a source of the internal SMI. In response to detecting the internal SMI, each processor core may further initiate an I/O cycle to a predetermined port address within the I/O hub. The I/O hub may broadcast an SMI message to each of the plurality of processor cores in response to receiving the I/O cycle. Each of the processor cores may further save to the SMM save state in the system memory, respective internal SMI source information in response to receiving the broadcast SMI message.

In one specific implementation, a selected one of the plurality of processor cores may read from the system memory, the SMM save state of all of the processor cores to determine within which processor core the internal SMI occurred. In addition, an SMI handler within the selected processor core may service the internal SMI of the processor core within which the internal SMI occurred.

### BRIEF DESCRIPTION OF THE DRAWINGS

FIG. 1 is a block diagram of one embodiment of a computer system including a multi-core processing node and a mechanism for broadcasting system management interrupts.

FIG. 2 is a flow diagram describing the operation of the embodiment of the computer system of FIG. 1.

FIG. 3 is a block diagram of another embodiment of a computer system including a mechanism for broadcasting system management interrupts.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

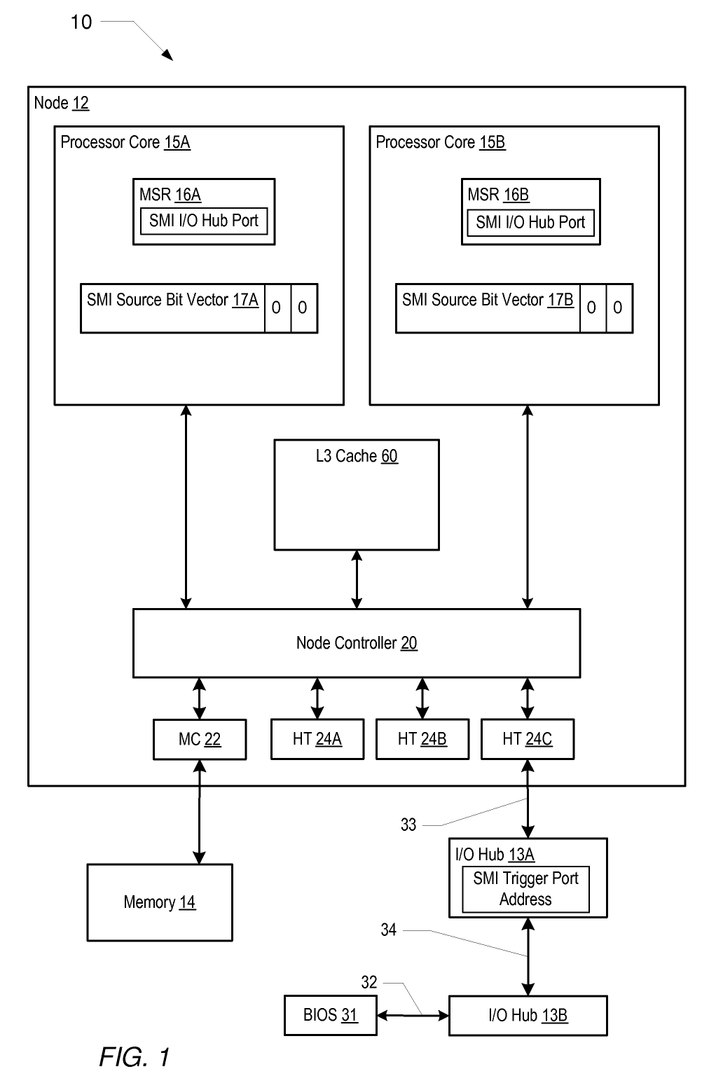

Turning now to FIG. 1, a block diagram of one embodiment of a computer system 10 is shown. In the illustrated embodiment, the computer system 10 includes a processing node 12 coupled to a memory 14 and to input/output (I/O) hubs 13A and 13B. The node 12 includes processor cores 15A and 15B, which are coupled to a node controller 20 which is further coupled to a memory controller 22, a plurality of HyperTransport™ (HT) interface circuits 24A through 24C, and a shared level three (L3) cache memory 60. The HT circuit 24C is coupled to the I/O hub 16A, which is coupled to the I/O hub 16B in a daisy-chain configuration (using HT interfaces, in this embodiment). The remaining HT circuits 24A-B may be connected to other similar processing nodes (not shown in FIG. 1) via other HT interfaces (not shown in FIG. 1). The memory controller 22 is coupled to the memory 14. In one embodiment, node 12 may be a single integrated circuit chip comprising the circuitry shown therein in FIG. 1. That is, node 12 may be a chip multiprocessor (CMP). Any level of integration or discrete components may be used. It is noted that processing node 12 may include various other circuits that have been omitted for simplicity.

In various embodiments, node controller 20 may also include a variety of interconnection circuits (not shown) for interconnecting processor cores 15A and 15B to each other, to other nodes, and to memory. Node controller 20 may also include functionality for selecting and controlling various node properties such as the maximum and minimum operating frequencies for the node, and the maximum and minimum power supply voltages for the node, for example. The node controller 20 may generally be configured to route communications between the processor cores 15A and 15B, the memory controller 22, and the HT circuits 24A-24C dependent upon the communication type, the address in the communication, etc. In one embodiment, the node controller 20 may include a system request queue (SRQ) (not shown) into which received communications are written by the node controller 20. The node controller 20 may schedule communications from the SRQ for routing to the destination or destinations among the processor cores 15A and 15B, the HT circuits 24A-24C, and the memory controller 22.

Generally, the processor cores 15A-15B may use the interface(s) to the node controller 20 to communicate with other components of the computer system 10 (e.g. I/O hubs 16A-16B, other processor cores (not shown), the memory controller 22, etc.). The interface may be designed in any desired fashion. Cache coherent communication may be defined for the interface, in some embodiments. In one embodiment, communication on the interfaces between the node controller 20 and the processor cores 15A and 15B may be in the form of packets similar to those used on the HT interfaces. In other embodiments, any desired communication may be used (e.g. transactions on a bus interface, packets of a different form, etc.). In other embodiments, the processor cores 15A and 15B may share an interface to the node controller 20 (e.g. a shared bus interface). Generally, the communications from the processor cores 15A and 15B may include requests such as read operations (to read a memory location or a register external to the processor core) and write operations (to write a memory location or external register), responses to probes (for cache coherent embodiments), interrupt acknowledgements, and system management messages, etc.

The HT circuits 24A-24C may comprise a variety of buffers and control circuitry for receiving packets from an HT link and for transmitting packets upon an HT link. The HT interface comprises two unidirectional links for transmitting packets. Each HT circuit 24A-24C may be coupled to two such links (one for transmitting and one for receiving). A given HT interface may be operated in a cache coherent fashion (e.g. between processing nodes) or in a non-coherent fashion (e.g. to/from I/O hubs 16A-16B). In the illustrated embodiment, the HT circuits 24A-24B are not in use, and the HT circuit 24C is coupled via a non-coherent link 33 to the I/O hubs 16A. Similarly, I/O hub 16A I coupled to I/O hub 16B via non-coherent link 34.

The I/O hubs 16A-16B may comprise any type of bridge and/or peripheral device. For example, the I/O hubs 16A-16B may be implemented as I/O tunnels in which HT packets may simply pass through to a next I/O hub. In addition, I/O hubs may include bridge interfaces to other types of buses and/or other peripheral devices. For example, in the illustrated embodiment I/O hub 16A is functioning as a tunnel while I/O hub 16B functioning as a bridge and is coupled to a basic input output system (BIOS) via a bus 32 such as an LPC bus, for example. Further, in some embodiments, I/O hubs 16A-16B may include devices for communicating with another computer system to which the devices may be coupled (e.g. network interface cards, circuitry similar to a network interface card that is integrated onto a main circuit board of a computer system, or modems). Furthermore, the I/O hubs 16A-16B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. It is noted that the term “peripheral device” is intended to encompass input/output (I/O) devices.

Generally, a processor core 15A-15B may include circuitry that is designed to execute instructions defined in a given instruction set architecture. That is, the processor core circuitry may be configured to fetch, decode, execute, and store results of the instructions defined in the instruction set architecture. For example, in one embodiment, processor cores 15A-15B may implement the x86 architecture. The processor cores 15A-15B may comprise any desired configurations, including superpipelined, superscalar, or combinations thereof. Other configurations may include scalar, pipelined, non-pipelined, etc. Various embodiments may employ out of order speculative execution or in order execution. The processor cores may include microcoding for one or more instructions or other functions, in combination with any of the above constructions. Various embodiments may implement a variety of other design features such as caches, translation lookaside buffers (TLBs), etc. Accordingly, in the illustrated embodiment, processor cores 15A and 15B each include a machine or model specific registers (MSRs) 16A and 16B, respectively. The MSR 16A and 16B may be programmed during boot-up. In one embodiment, MSR 16A and 16B may be programmed with a port address value. As described in greater detail below, in response to a given processor core 15 detecting an internal system management interrupt (SMI) the processor core 15 may initiate an I/O cycle (either a read or write depending upon the implementation) to the I/O hub 13A at the port address specified in MSR 16.

In the illustrated embodiment, each of processor cores 15A and 15B also includes an SMI source bit vector designated 17A and 17B, respectively. Each SMI source bit vector 17 includes a number bits and each bit corresponds to an internal SMI source. In one embodiment, the SMI source bit vectors may be software constructs. In other embodiments they may be implemented as hardware registers, or any combination thereof. As described further below, in response to a given processor core 15 detecting an internal system management interrupt (SMI) the processor core 15 may assert the bit that corresponds to the source that generated the SMI.

It is noted that, while the present embodiment uses the HT interface for communication between nodes and between a node and peripheral devices, other embodiments may use any desired interface or interfaces for either communication. For example, other packet based interfaces may be used, bus interfaces may be used, various standard peripheral interfaces may be used (e.g., peripheral component interconnect (PCI), PCI express, etc.), etc.

As described above, the memory 14 may include any suitable memory devices. For example, a memory 14 may comprise one or more random access memories (RAM) in the dynamic RAM (DRAM) family such as RAMBUS DRAMs (RDRAMs), synchronous DRAMs (SDRAMs), double data rate (DDR) SDRAM. Alternatively, memory 14 may be implemented using static RAM, etc. The memory controller 22 may comprise control circuitry for interfacing to the memories 14. Additionally, the memory controller 22 may include request queues for queuing memory requests, etc. As will be described in greater detail below, memory controller 22 may be configured to request data from the memory 14 in response to a request from a processor core (e.g., 15A). In addition, the memory 14 may respond to such a request by providing not only the requested data block(s) but also additional data blocks that were not requested. Accordingly, memory controller 22 may selectively store the additional data blocks within the L3 cache 60.

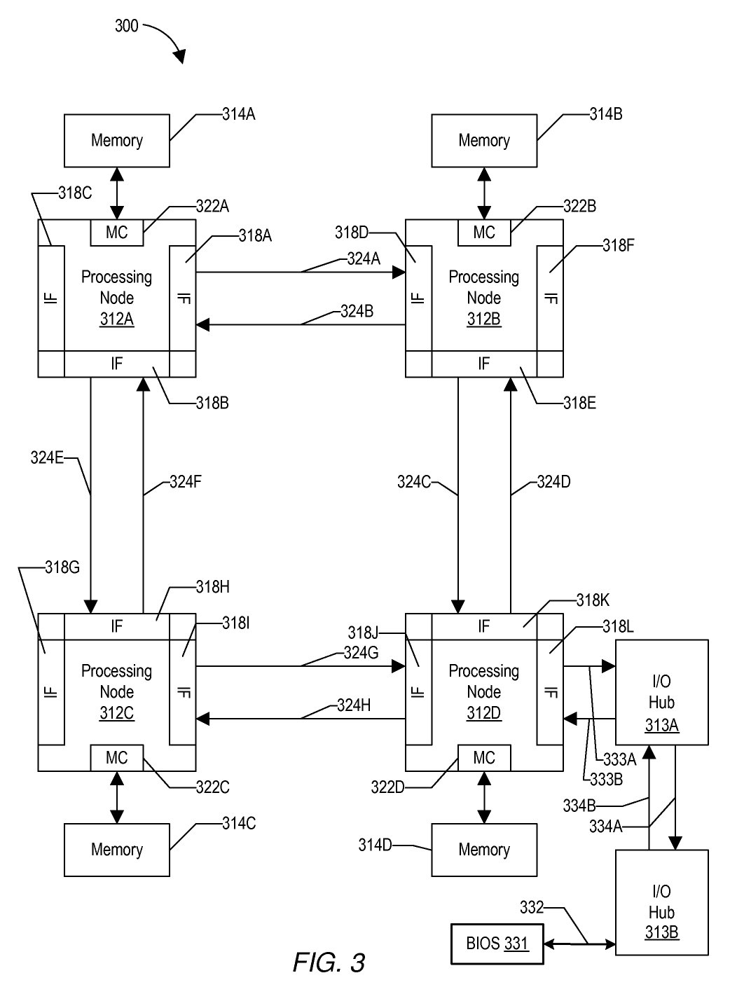

It is noted that, while the computer system 10 illustrated in FIG. 1 includes one processing node 12, other embodiments such as that shown in FIG. 3 may implement any number of processing nodes. Similarly, a processing node such as node 12 may include any number of processor cores, in various embodiments. Various embodiments of the computer system 10 may also include different numbers of HT interfaces per node 12, and differing numbers of peripheral devices 16 coupled to the node, etc.

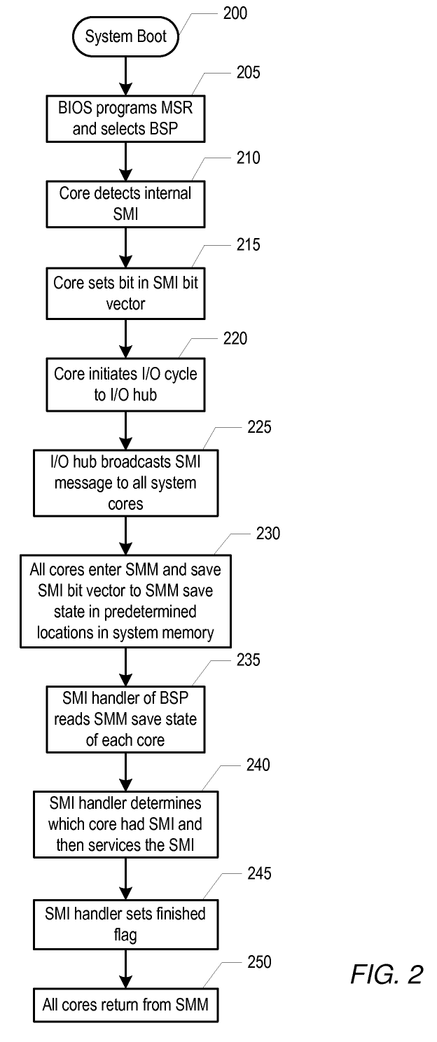

FIG. 2 is a flow diagram describing the operation of the embodiment shown in FIG. 1. Referring collectively to FIG. 1 and FIG. 2, during a power on reset, or initial system boot, the BIOS code begins executing in one of the processor cores. Typically one of the cores is designated by the BIOS as a boot strap processor (BSP). In one embodiment, the BIOS code programs the MSR 16A and 16B with predetermined port address of I/O hub 16A (block 205).

During system operation, if a processor core such as processor core 15A, for example, detects an internal SMI (block 210), that processor core sets the corresponding bit within the SMI source bit vector 17A (block 215). Processor core 15A initiates an I/O cycle to the port address specified in MSR 16A of I/O hub 13A (block 220). In one implementation, the I/O cycle may be a write transaction. In other implementations, the I/O cycle may be a read transaction. In either case, I/O hub 13A recognizes an I/O cycle to that port address as an SMI message from one of the processor cores.

In response to receiving the transaction on that port address, I/O hub 13A broadcasts an SMI message to all processor cores in the system (block 225). In the illustrated embodiment, both processor cores 15A and 15B may receive the broadcast message. As each processor core 15 receives the broadcast message, that core enters the system management mode (SMM). In one embodiment, each processor core 15 stores the SMI source bit vector 17 to a predetermined location in the SMM save state in memory 14 along with any other SMM save state information (block 230). For example, processor core 15B may receive the SMI broadcast message first and may store the SMM save state to memory 14 followed by processor core 15A saving its SMM save state information to memory 14. In one embodiment, once a processor core enters the SMM the processor core may set a flag in memory 14 to indicate that it has entered the SMM.

Processor cores that implement the x86 architecture typically include an SMI handler. In one embodiment, the BSP (in this example, processor core 15B is the BSP) SMI handler performs read transactions to memory 14 to read the SMM save state information of each processor core in the system (block 235). The BSP SMI handler determines which processor core had the SMI and what the source of the SMI was by reading the SMI source bit vector 17. The SMI handler services the SMI, even though the SMI was generated in another processor core (block 240). When the SMI handler finishes servicing the SMI, the SMI handler asserts a finish flag (block 245). In one embodiment, the SMI finish flag may be a predetermined memory location that each processor core monitors while in SMM. As each processor core 15 (in this example processor core 15A determines the flag now indicates the SMI handler is finished, in one embodiment, the processor core 15A issues a resume (RSM) instruction to exit the SMM (block 250).

The embodiments described above include a single multicore processor node. In FIG. 3, another embodiment of a computer system 300 including multiple processing nodes is shown. Referring to FIG. 3, computer system 300 includes several processing nodes designated 312A, 312B, 312C, and 312D coupled together. Each processing node is coupled to a respective memory 314A-314D via a memory controller 322A-322D included within each respective processing node 312A-312D. In addition, processing node 312d is coupled to an I/O hub 313A, which is coupled to I/O hub 313B, which is turn coupled to BIOS 331.

As shown processing nodes 312A-312D include interface logic used to communicate between the processing nodes 312A-312D. For example, processing node 312A includes interface logic 318A for communicating with processing node 312B, interface logic 318B for communicating with processing node 312C, and a third interface logic 318C for communicating with yet another processing node (not shown). Similarly, processing node 312B includes interface logic 318D, 318E, and 318F; processing node 312C includes interface logic 318G, 318H, and 318I; and processing node 312D includes interface logic 318J, 318K, and 318L. Processing node 312D is coupled to communicate with a plurality of input/output devices (e.g. hubs 313A-313B in a daisy chain configuration) via interface logic 318L. It is noted that in some embodiments interface logic 318L may be referred to as a host bridge since it is coupled to I/O hub 313A. Other processing nodes may communicate with other I/O devices in a similar fashion.

Similar to processing node 12 of FIG. 1, processing nodes 312A-312D may also implement a number of packet-based links for inter-processing node communication. In the present embodiment, each link is implemented as a set of unidirectional lines (e.g. lines 324A are used to transmit packets from processing node 312A to processing node 312B and lines 324B are used to transmit packets from processing node 312B to processing node 312A). Other sets of lines 324C-324H are used to transmit packets between other processing nodes as illustrated in FIG. 6. Generally, each set of lines 324 may include one or more data lines, one or more clock lines corresponding to the data lines, and one or more control lines indicating the type of packet being conveyed. In one embodiment, the links may be operated in a cache coherent fashion for communication between processing nodes. The processing nodes 312 may also operate one or more of the links in a non-coherent fashion for communication between a processing node and an I/O device (or a bus bridge to an I/O bus of conventional construction such as the Peripheral Component Interconnect (PCI) bus or Industry Standard Architecture (ISA) bus). Furthermore, one or more links may be operated in a non-coherent fashion using a daisy-chain structure between I/O devices as shown. For example, links 333 and 334 which includes sets of lines 333A and 333B, and 334A and 33B may be operated in a non-coherent fashion. It is noted that a packet to be transmitted from one processing node to another may pass through one or more intermediate nodes. For example, a packet transmitted by processing node 312A to processing node 312D may pass through either processing node 312B or processing node 312C as shown in FIG. 3. Any suitable routing algorithm may be used. Other embodiments of computer system 300 may include more or fewer processing nodes then the embodiment shown in FIG. 3.

Generally, the packets may be transmitted as one or more bit times on the lines 324 between nodes. A bit time may be the rising or falling edge of the clock signal on the corresponding clock lines. The packets may include command packets for initiating transactions, probe packets for maintaining cache coherency, and response packets from responding to probes and commands.

Processing nodes 312A-312D, in addition to a memory controller and interface logic, may include one or more processor cores. Broadly speaking, a processing node comprises at least one processor core and may optionally include a memory controller for communicating with a memory and other logic as desired. More particularly, each processing node 312A-312D may comprise one or more copies of processor node 12 as shown in FIG. 1. One or more processors may comprise a chip multiprocessing (CMP) or chip multithreaded (CMT) integrated circuit in the processing node or forming the processing node, or the processing node may have any other desired internal structure.

Memories 314A-314D may comprise any suitable memory devices. For example, a memory 314A-314D may comprise one or more RAMBUS DRAMs (RDRAMs), synchronous DRAMs (SDRAMs), DDR SDRAM, static RAM, etc. The address space of computer system 300 is divided among memories 314A-314D. Each processing node 312A-312D may include a memory map used to determine which addresses are mapped to which memories 314A-314D, and hence to which processing node 312A-312D a memory request for a particular address should be routed. In one embodiment, the coherency point for an address within computer system 300 is the memory controller 316A-316D coupled to the memory storing bytes corresponding to the address. In other words, the memory controller 316A-316D is responsible for ensuring that each memory access to the corresponding memory 314A-314D occurs in a cache coherent fashion. Memory controllers 316A-316D may comprise control circuitry for interfacing to memories 314A-314D. Additionally, memory controllers 316A-316D may include request queues for queuing memory requests.

Generally, interface logic 318A-318L may comprise a variety of buffers for receiving packets from the link and for buffering packets to be transmitted upon the link. Computer system 300 may employ any suitable flow control mechanism for transmitting packets. For example, in one embodiment, each interface logic 318 stores a count of the number of each type of buffer within the receiver at the other end of the link to which that interface logic is connected. The interface logic does not transmit a packet unless the receiving interface logic has a free buffer to store the packet. As a receiving buffer is freed by routing a packet onward, the receiving interface logic transmits a message to the sending interface logic to indicate that the buffer has been freed. Such a mechanism may be referred to as a “coupon-based” system.

I/O hubs 313A-313B may be any suitable I/O devices. For example, I/O hubs 313A-313B may include devices for communicating with another computer system to which the devices may be coupled (e.g. network interface cards or modems). Furthermore, I/O hubs 313A-313B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. Furthermore, any I/O device implemented as a card may also be implemented as circuitry on the main circuit board of the system 300 and/or software executed on a processing node. It is noted that the term “I/O device” and the term “peripheral device” are intended to be synonymous herein.

It is noted that each of processing nodes 312A through 312D in FIG. 3 may include the functionality of the processing node 12 of FIG. 1. As such, in response to an internal SMI within a given processor core, that processor core may perform similar functions as the processor cores shown in FIG. 1. Likewise, I/O hub 313A of FIG. 3 may include the functionality of the I/O hub 13A of FIG. 1. Accordingly, in response to an I/O cycle received through the predetermined port address as described above, I/O hub 313A may broadcast an SMI message to all processor cores of all processing nodes within computer system 300.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer system comprising:
a system memory;
a plurality of processor cores coupled to the system memory, wherein in response to detecting an occurrence of an internal system management interrupt (SMI), each of the processor cores is configured to save to a system management mode (SMM) save state in the system memory, information corresponding to a source of the internal SMI;
an input/output (I/O hub) configured to communicate with each of the processor cores;
wherein in response to detecting the internal SMI, each processor core is further configured to initiate an I/O cycle to a predetermined port address within the I/O hub;
wherein the I/O hub is configured to broadcast an SMI message to each of the plurality of processor cores in response to receiving the I/O cycle;
wherein each of the processor cores is further configured to save to the SMM save state in the system memory, respective internal SMI source information in response to receiving the broadcast SMI message.

2. The computer system as recited in claim 1, wherein a selected one of the plurality of processor cores is configured to read from the system memory, the SMM save state of all of the processor cores to determine within which processor core the internal SMI occurred.

3. The computer system as recited in claim 2, wherein an SMI handler within the selected processor core is configured to service the internal SMI of the processor core within which the internal SMI occurred.

4. The computer system as recited in claim 2, wherein the selected processor core is selected during a boot-up process by a basic input/output system (BIOS).

5. The computer system as recited in claim 4, wherein the predetermined port address is programmed into a model specific register of each of the processor cores during the boot-up process by the BIOS.

6. The computer system as recited in claim 1, wherein the I/O cycle comprises a write transaction.

7. The computer system as recited in claim 1, wherein the I/O cycle comprises a read transaction.

8. The computer system as recited in claim 1, wherein the information corresponding to a source of the internal SMI comprises a bit vector having a plurality of bits each corresponding to a respective source of an internal SMI.

9. A method comprising:
a processor core of a plurality of processor cores detecting an occurrence of an internal system management interrupt (SMI);
the processor core saving to a system management mode (SMM) save state in a system memory, information corresponding to a source of the internal SMI in response to detecting the occurrence of the internal SMI;
the processor core initiating an I/O cycle to a predetermined port address within an I/O hub that is communicating with each of the plurality of processor cores, in response to detecting the internal SMI;
the I/O hub broadcasting an SMI message to each of the plurality of processor cores in response to receiving the I/O cycle;
wherein in response to each of the plurality of processor cores receiving the broadcast SMI message, each of the plurality of processor cores saving to the SMM save state in the system memory, respective internal SMI source information.

10. The method as recited in claim 9, further comprising a selected one of the plurality of processor cores reading from the system memory, the SMM save state of all of the processor cores, and determining within which processor core the internal SMI occurred.

11. The method as recited in claim 10, further comprising an SMI handler within the selected processor core servicing the internal SMI of the processor core within which the internal SMI occurred.

12. The method as recited in claim 10, further comprising a basic input/output system (BIOS) selecting the selected processor core during a boot-up process.

13. The method as recited in claim 12, further comprising the BIOS programming the predetermined port address into a model specific register of each of the processor cores during the boot-up process.

14. The method as recited in claim 9, wherein the I/O cycle comprises a write transaction.

15. The method as recited in claim 9, wherein the I/O cycle comprises a read transaction.

16. The method as recited in claim 9, wherein the information corresponding to a source of the internal SMI comprises a bit vector having a plurality of bits each corresponding to a respective source of an internal SMI.

17. A computer system comprising:
a plurality of system memories;
a plurality of processing nodes, wherein one or more processing nodes of the plurality of processing nodes is coupled to a respective system memory;
wherein each of the processing nodes includes a plurality of processor cores, each configured to save to a system management mode (SMM) save state in the respective system memory, information corresponding to a source of an internal system management interrupt (SMI) in response to detecting an occurrence of the internal SMI;
an input/output (I/O hub) coupled to one processing node of the plurality of processing nodes and configured to communicate with each of the processor cores of each processing node;
wherein in response to detecting the internal SMI, each processor core is further configured to initiate an I/O cycle to a predetermined port address within the I/O hub;
wherein the I/O hub is configured to broadcast an SMI message to each of the processor cores of each processing node in response to receiving the I/O cycle;
wherein each of the processor cores of each processing node is further configured to save to the SMM save state in the respective system memory, respective internal SMI source information in response to receiving the broadcast SMI message.

18. The computer system as recited in claim 17, wherein a selected one of the plurality of processor cores of one of the plurality of processing nodes is configured to read from all of the system memories, the SMM save state of all of the processor cores to determine within which processor core the internal SMI occurred.

19. The computer system as recited in claim 18, wherein an SMI handler within the selected processor core is configured to service the internal SMI of the processor core within which the internal SMI occurred.

20. The computer system as recited in claim 18, wherein the selected processor core is selected during a boot-up process by a basic input/output system (BIOS).

21. The computer system as recited in claim 20, wherein the predetermined port address is programmed into a model specific register of each of the processor cores during the boot-up process by the BIOS.

22. The computer system as recited in claim 17, wherein the information corresponding to a source of the internal SMI comprises a bit vector having a plurality of bits each corresponding to a respective source of an internal SMI.
